(19) United States
(12) Patent Application Publication
(10) Pub. No.: US 2026/0343472 A1
(43) Pub. Date: Oct. 29, 2026

(54) SIDELINK POSITIONING REFERENCE SIGNAL (SL-PRS) CONFIGURATION HANDLING

(71) Applicant: Telefonaktiebolaget LM Ericsson (publ), Stockholm (SE)

(72) Inventors: Florent MUNIER, VÄSTRA FRÖLUNDA (SE); Mohammed Yazid LYAZIDI, London (GB); Ritesh SHREEVASTAV, UPPLANDS VÄSBY (SE); Siva MURUGANATHAN, STITTSVILLE (CA)

(73) Assignee: Telefonaktiebolaget LM Ericsson (publ), Stockholm (SE)

(21) Appl. No.: 19/120,153

(22) PCT Filed: Sep. 15, 2023
(86) PCT No.: PCT/EP2023/075521

§ 371 Date: Apr. 10, 2025

Related U.S. Application Data
(60) Provisional application No. 63/415,122, filed on Oct. 11, 2022.

(51) Int. Cl. H04W 64/00; H04L 5/00; H04W 92/18

(52) U.S. Cl. CPC H04W 64/00; H04L 5/0051; H04W 92/18

(57) ABSTRACT

The present disclosure is related to a network node, RAN nodes, and methods for handling SL-PRS configuration. A method performed by a LMF for a communications system comprises: obtaining from a first RAN node, TRP SL-PRS resource configuration capabilities for one or more TRPs associated with the first RAN node; and sending, to the first RAN node, a request for start of SL-PRS resource allocation to be performed by the first RAN node.

### CROSS-REFERENCE TO RELATED APPLICATIONS

This application is a 35 U.S.C. § 371 national stage application of PCT International Application No. PCT/EP2023/075521 filed on Sep. 15, 2023, which in turn claims priority to the U.S. provisional patent application No. 63/415,122, entitled “METHODS FOR HANDLING SIDELINK POSITIONING REFERENCE SIGNAL CONFIGURATION IN NG-RAN’, filed on Oct. 11, 2022, the disclosures and content of each of which are incorporated by reference herein in their entirety.

### TECHNICAL FIELD

The present disclosure is related to the field of telecommunication, and in particular, to a network node, Radio Access Network (RAN) nodes, and methods for handling a Sidelink Positioning Reference Signal (SL-PRS) configuration.

### BACKGROUND

With the development of the electronic and telecommunication technologies, mobile devices, such as a mobile phone, a smart phone, a laptop, a tablet, a vehicle mounted device, becomes an important part of our daily lives. One of the key features provided by a mobile device is location-based service (LBS). Because of the popularities of social networks and the widespread usage of mobile devices, demands for LBS are increased in both indoor and outdoor environments.

Positioning could be done with or without utilizing cellular mobile communication networks (e.g., 4th Generation (4G) Long Term Evolution (LTE) or 5th Generation (5G) New Radio (NR) networks). There are many positioning schemes without utilizing cellular mobile communication networks (i.e., the third-party schemes), for example, the schemes may exploit some certain combinations of the following technologies: Wi-Fi fingerprinting, ZigBee/Bluetooth fingerprinting, geomagnetic fingerprinting, inertial navigation, Radio Frequency Identification (RFID), Ultra Wideband (UWB) communications, visible light communications, ultrasonic wave, infrared ray, map matching, etc. Further, a new Sidelink (SL) based positioning scheme is drawing more attention recently.

Networks have always been hierarchical in nature. Devices have connected to and communicated with one or more base stations ever since the birth of cellular communications. However, as the new technology enabler in 5G NR, SL will allow devices to connect directly to one another. Sidelink is the new communication paradigm in which cellular devices are able to communicate without relaying their data via the network. That means vehicles, robots, and even consumer gadgets could create their own ad hoc networks without using the radio access network as an intermediary.

### SUMMARY

In the 3^{rd} Generation Partnership Project (3GPP) RAN #94, the RAN plenary approved the following objective on sidelink positioning, as detailed in RP-213588:

Study and evaluate performance and feasibility of potential solutions
for SL positioning, considering relative positioning, ranging and
absolute positioning: [RAN1, RAN2]
Evaluate bandwidth requirement needed to meet the identified
accuracy requirements [RAN1]
Study of positioning methods (e.g. TDOA, RTT, AOA/D, etc)
including combination of SL positioning measurements with other
RAT dependent positioning measurements (e.g. Uu based
measurements) [RAN1]
Study of sidelink reference signals for positioning purposes from
physical layer perspective, including signal design, resource
allocation, measurements, associated procedures, etc, reusing
existing reference signals, procedures, etc from sidelink
communication and from positioning as much as possible [RAN1]
Study of positioning architecture and signalling procedures (e.g.
configuration, measurement reporting, etc) to enable sidelink
positioning covering both UE based and network based positioning
[RAN2, includingcoordination and alignment with RAN3 and SA2
as required].

(emphasis added)

RAN2 made the following agreements on sidelink scenarios and architecture at RAN2 #119-e:

Agreement
For the purpose of RAN1 discussion during this study item, at least the following
terminology is used:
Target UE: UE to be positioned (in this context, using SL, i.e. PC5 interface).
Sidelink positioning: Positioning UE using reference signals transmitted over SL,
i.e., PC5 interface, to obtain absolute position, relative position, or ranging
information.
Ranging: determination of the distance and/or the direction between a UE and
another entity, e.g., anchor UE.
Sidelink positioning reference signal (SL PRS): reference signal transmitted
over SL for positioning purposes.
SL PRS (pre-)configuration: (pre-)configured parameters of SL PRS such as
time-frequency resources (other parameters are not precluded) including its
bandwidth and periodicity.
Continue discussion on additional terminology clarification(s) such as: Initiator UE,
Responder UE, Sidelink Positioning group, reference UE, etc, including whether such
terminology is needed within RAN1 discussion.
Agreement
For the purpose of RAN1 discussion during this study item, at least the following
terminology is used:
Anchor UE: UE supporting positioning of target UE, e.g., by transmitting and/or
receiving reference signals for positioning, providing positioning-related information,
etc., over the SL interface.
FFS: clarification of the knowledge of the location of the anchor UE
Agreements:
Proposal 1 (modified): Confirm that for sidelink positioning in-coverage, partial coverage
and out-of-coverage scenarios shall be supported. FFS if partial coverage case assumes
anything about which UEs are in coverage.
Proposal 2: Study the architecture and signaling procedures to enable at least the
following two operation scenarios:
Operation Scenario 1: PC5-only-based positioning.
Operation Scenario 2: Combination of Uu- and PC5-based positioning.
Agreement:
RAN2 follow SA2 on the architecture, including the possibility of a UE as a location
server. FFS from RAN2 perspective if there are cases without a UE in the location server
role.
Agreements:
Introduce a new protocol for sidelink positioning procedures between UEs (name FFS,
e.g., RSPP, SLPP). FFS where it is specified.
The new protocol is a separate ASN.1 module from LPP (this does not necessarily imply
whether it is included in 37.355).

FIG. 1 presents the sidelink positioning architecture in 3GPP Rel-18 that is considered as baseline, which will be described in details below.

RAN1 made the following agreements during RAN1 #110-e on SL positioning methods and resource allocation:

Agreement
With regards to the Positioning methods supported using at least SL
measurements, potential candidate positioning methods include at least
the following:
RTT-type solution(s) using SL
SL-AoA
SL-TDOA
Note: other methods can still be studied
Note: The above categorization does not necessarily mean that there
will be separate SL positioning methods specified.
Agreement
A new reference signal should be introduced for supporting SL
positioning/ranging.
Agreement
Regarding SL-PRS resource allocation, both Scheme 1 and Scheme 2
should be introduced for supporting SL positioning/ranging:
Scheme 1: Network-centric operation SL-PRS resource allocation
(e.g. similar to a legacy Mode 1 solution)
The network (e.g. gNB, LMF, gNB & LMF) allocates resources for
SL-PRS.
Scheme 2: UE autonomous SL-PRS resource allocation (e.g. similar
to legacy Mode 2 solution)
At least one of the UE(s) participating in the sidelink positioning
operation allocates resources for SL-PRS

RAN3 needs to study the signaling needed (e.g., New Radio (NR) Positioning Protocol A (NRPPA), F1AP, XnAP and Next Generation (NG) Application Protocol (NGAP)) to support sidelink positioning in the different schemes. For sidelink positioning resources, new reference signal would be introduced and network-centric operation for Sidelink Positioning Reference Signal (SL-PRS) resource allocation would be introduced for supporting SL positioning/ranging. The above agreements have pointed out that next generation Node B (gNB) or Location Management Function (LMF) or gNB and LMF may be involved in resource allocation.

There currently exist certain challenge(s). In case new SL-PRS would be introduced for sidelink positioning, RAN3 signalling procedures will be needed. The signaling details are not known and the exact signaling details are an open problem to be solved.

Therefore, to address or at least alleviate at least one of the above issues, some embodiments of the present disclosure are provided.

According to a first aspect of the present disclosure, a method performed by a Location Management Function (LMF) for a communications system is provided. The method comprises: obtaining, from a first RAN node, Transmission and Reception Point (TRP) SL-PRS resource configuration capabilities for one or more TRPs associated with the first RAN node; and sending, to the first RAN node, a request for start of SL-PRS resource allocation to be performed by the first RAN node.

In some embodiments, the request for start of SL-PRS resource allocation comprises assistance data. In some embodiments, the assistance data comprises one or more recommended parameters for SL-PRS resource allocation that are based on at least the TRP SL-PRS resource configuration capabilities for the one or more TRPs associated with the first RAN node. In some embodiments, the one or more recommended parameters comprise at least one of: a recommended periodicity for the SL-PRS resource allocation; a start time for the SL-PRS resource allocation; frequency information for the SL-PRS resource allocation; a muting pattern for the SL-PRS resource allocation; and Quasi Co-Location (QCL) information for the SL-PRS resource allocation. In some embodiments, the assistance data comprises information about whether a SL-PRS resource pool should be shared with a resource pool used for SL communications or whether the SL-PRS resource pool should be a dedicated resource pool separate from the resource pool used for SL communications.

In some embodiments, the method further comprises: receiving, from one or more User Equipments (UEs), one or more UE capabilities, each of which indicating whether the corresponding UE supports a common resource pool for SL-PRS and SL communications or separate resource pools for SL-PRS and SL communications. In some embodiments, obtaining the TRP SL-PRS resource configuration capabilities for the one or more TRPs associated with the first RAN node comprises: sending, to the first RAN node, a request for TRP SL-PRS resource configuration capabilities; and receiving, from the first RAN node, a response comprising the TRP SL-PRS resource configuration capabilities for the one or more TRPs associated with the first RAN node in response to the request. In some embodiments, the method further comprises: in response to sending the request for start of SL-PRS resource allocation, receiving, from the first RAN node, a response indicating whether or not the SL-PRS resource allocation is successfully performed. In some embodiments, the TRP SL-PRS resource configuration capabilities comprise at least one of: a capability of providing one or more UEs with SL-PRS resource allocation configuration for scheme 2; and a capability of sending Downlink Control Information (DCI) information to one or more UEs for requesting the one or more UEs to transmit SL-PRS.

According to a second aspect of the present disclosure, a network node hosting an LMF is provided. The network node comprises: a processor; a memory storing instructions which, when executed by the processor, cause the LMF to: obtain, from a first RAN node, TRP SL-PRS resource configuration capabilities for one or more TRPs associated with the first RAN node; and send, to the first RAN node, a request for start of SL-PRS resource allocation to be performed by the first RAN node. In some embodiments, the instructions, when executed by the processor, cause the LMF further to perform any of the methods of the first aspect.

According to a third aspect of the present disclosure, a network node hosting an LMF is provided. The network node comprises: an obtaining module configured to obtain, from a first RAN node, TRP SL-PRS resource configuration capabilities for one or more TRPs associated with the first RAN node; and a sending module configured to send, to the first RAN node, a request for start of SL-PRS resource allocation to be performed by the first RAN node. In some embodiments, the network node may comprise one or more further modules, each of which may perform any of the steps of any of the methods of the first aspect.

According to a fourth aspect of the present disclosure, a method performed by a first RAN node is provided. The method comprises: providing, to a LMF, TRP SL-PRS resource configuration capabilities for one or more TRPs associated with the first RAN node; and receiving, from the LMF, a request for start of SL-PRS resource allocation to be performed by the first RAN node.

In some embodiments, the request for start of SL-PRS resource allocation comprises assistance data. In some embodiments, the method further comprises at least one of: sending, to one or more other RAN nodes, the assistance data received from the LMF; and receiving, from one or more other RAN nodes, assistance data for SL-PRS resource allocation. In some embodiments, the assistance data comprises one or more recommended parameters for SL-PRS resource allocation that are based on at least the TRP SL-PRS resource configuration capabilities for the one or more TRPs associated with the first RAN node. In some embodiments, the one or more recommended parameters comprise at least one of: a recommended periodicity for the SL-PRS resource allocation; a start time for the SL-PRS resource allocation; frequency information for the SL-PRS resource allocation; a muting pattern for the SL-PRS resource allocation; and QCL information for the SL-PRS resource allocation. In some embodiments, the assistance data comprises information about whether a SL-PRS resource pool should be shared with a resource pool used for SL communications or whether the SL-PRS resource pool should be a dedicated resource pool separate from the resource pool used for SL communications.

In some embodiments, the method further comprises: receiving, from the LMF, a request for TRP SL-PRS resource configuration capabilities. In some embodiments, providing the TRP SL-PRS resource configuration capabilities for the one or more TRPs associated with the first RAN node comprises sending, to the LMF, a response comprising the TRP SL-PRS resource configuration capabilities for the one or more TRPs associated with the first RAN node in response to the request. In some embodiments, the first RAN node is a Centralized Unit (CU) of a base station. In some embodiments, the method further comprises: sending, to a Distributed Unit (DU) of the base station, a request for TRP SL-PRS resource configuration capabilities for one or more TRPs associated with the DU; and receiving, from the DU, a response comprising the TRP SL-PRS resource configuration capabilities for one or more TRPs associated with the DU.

In some embodiments, the first RAN node is a CU of a base station, and the method further comprises: in response to receiving the request for start of SL-PRS resource allocation to be performed by the first RAN node, sending, to a DU of the base station, a request to configure SL-PRS resources in accordance with at least the request for start of SL-PRS resource allocation received from the LMF. In some embodiments, the request to configure SL-PRS resources comprises at least a part of the assistance data and/or is at least partially derived from the assistance data. In some embodiments, the method further comprises: in response to sending the request to configure SL-PRS resources, receiving, from the DU, a response indicating whether or not the SL-PRS resource allocation is performed.

In some embodiments, the method further comprises: sending, to the LMF, a response indicating whether or not the SL-PRS resource allocation is performed based on at least the response received from the DU indicating whether or not the SL-PRS resource allocation is performed. In some embodiments, when the response received from the DU indicates a successful SL-PRS resource allocation, the response further comprises a Radio Resource Control, RRC, container in which an SL-PRS resource configuration is encoded. In some embodiments, the method further comprises: sending to a UE, a message comprising the RRC container in which the SL-PRS resource configuration is encoded. In some embodiments, the method further comprises at least one of: sending, to one or more other RAN nodes, the SL-PRS resource configuration; and receiving, from one or more other RAN nodes, one or more SL-PRS resource configurations for one or more UEs.

In some embodiments, the TRP SL-PRS resource configuration capabilities comprise at least one of: a capability of providing one or more UEs with SL-PRS resource allocation configuration for scheme 2; and a capability of sending DCI information to one or more UEs for requesting the one or more UEs to transmit SL-PRS.

According to a fifth aspect of the present disclosure, a first RAN node is provided. The first RAN node comprises: a processor; a memory storing instructions which, when executed by the processor, cause the first RAN node to: provide, to an LMF, TRP SL-PRS resource configuration capabilities for one or more TRPs associated with the first RAN node; and receive, from the LMF, a request for start of SL-PRS resource allocation to be performed by the first RAN node. In some embodiments, the instructions, when executed by the processor, cause the first RAN node further to perform any of the methods of the fourth aspect.

According to a sixth aspect of the present disclosure, a first RAN node is provided. The first RAN node comprises: a providing module configured to provide, to an LMF, TRP SL-PRS resource configuration capabilities for one or more TRPs associated with the first RAN node; and a receiving module configured to receive, from the LMF, a request for start of SL-PRS resource allocation to be performed by the first RAN node. In some embodiments, the first RAN node may comprise one or more further modules, each of which may perform any of the steps of any of the methods of the fourth aspect.

According to a seventh aspect of the present disclosure, a method performed by a second RAN node is provided. The method comprises: providing, to a first RAN node, TRP SL-PRS resource configuration capabilities for one or more TRPs associated with the second RAN node; and receiving, from the first RAN node, a request for start of SL-PRS resource allocation to be performed by the second RAN node.

In some embodiments, the request for start of SL-PRS resource allocation comprises assistance data. In some embodiments, the assistance data comprises one or more recommended parameters for SL-PRS resource allocation that are based on at least the TRP SL-PRS resource configuration capabilities for the one or more TRPs associated with the second RAN node. In some embodiments, the one or more recommended parameters comprise at least one of: a recommended periodicity for the SL-PRS resource allocation; a start time for the SL-PRS resource allocation; frequency information for the SL-PRS resource allocation; a muting pattern for the SL-PRS resource allocation; and Quasi Co-Location, QCL, information for the SL-PRS resource allocation. In some embodiments, the assistance data comprises information about whether a SL-PRS resource pool should be shared with a resource pool used for SL communications or whether the SL-PRS resource pool should be a dedicated resource pool separate from the resource pool used for SL communications.

In some embodiments, the method further comprises: receiving, from the first RAN node, a request for TRP SL-PRS resource configuration capabilities. In some embodiments, providing the TRP SL-PRS resource configuration capabilities for the one or more TRPs associated with the second RAN node comprises sending, to the first RAN node, a response comprising the TRP SL-PRS resource configuration capabilities for the one or more TRPs associated with the second RAN node in response to the request. In some embodiments, the second RAN node is a DU of a base station and the first RAN node is a CU of the base station, and the method further comprises: in response to receiving the request for start of SL-PRS resource allocation to be performed by the second RAN node, configuring SL-PRS resources in accordance with at least the request for start of SL-PRS resource allocation received from the first RAN node. In some embodiments, the method further comprises: transmitting, to the first RAN node, a response indicating whether or not the SL-PRS resource allocation is performed based on at least whether or not the SL-PRS resources are configured successfully. In some embodiments, when the SL-PRS resources are configured successfully, the response further comprises a Radio Resource Control, RRC, container in which an SL-PRS resource configuration is encoded by the second RAN node. In some embodiments, the TRP SL-PRS resource configuration capabilities comprise at least one of: a capability of providing one or more UEs with SL-PRS resource allocation configuration for scheme 2; and a capability of sending Downlink Control Information, DCI, information to one or more UEs for requesting the one or more UEs to transmit SL-PRS.

According to an eighth aspect of the present disclosure, a second RAN node is provided. The second RAN node comprises: a processor; a memory storing instructions which, when executed by the processor, cause the second RAN node to: provide, to a first RAN node, TRP SL-PRS resource configuration capabilities for one or more TRPs associated with the second RAN node; and receive, from the first RAN node, a request for start of SL-PRS resource allocation to be performed by the second RAN node. In some embodiments, the instructions, when executed by the processor, cause the second RAN node further to perform any of the methods of the seventh aspect.

According to a ninth aspect of the present disclosure, a second RAN node is provided. The second RAN node comprises: a providing module configured to provide, to a first RAN node, TRP SL-PRS resource configuration capabilities for one or more TRPs associated with the second RAN node; and a receiving module configured to receive, from the first RAN node, a request for start of SL-PRS resource allocation to be performed by the second RAN node. In some embodiments, the second RAN node may comprise one or more further modules, each of which may perform any of the steps of any of the methods of the seventh aspect.

According to a tenth aspect of the present disclosure, a computer program comprising instructions is provided. The instructions, when executed by at least one processor, cause the at least one processor to carry out any of the methods of any of the first aspect, the fourth aspect, and the seventh aspect.

According to an eleventh aspect of the present disclosure, a carrier containing the computer program of the tenth aspect is provided. In some embodiments, the carrier is one of an electronic signal, optical signal, radio signal, or computer readable storage medium.

According to a twelfth aspect of the present disclosure, a telecommunication system is provided. The telecommunication system comprises: a network node hosting an LMF comprising: a processor; a memory storing instructions which, when executed by the processor, cause the LMF to: obtain, from a first RAN node, TRP SL-PRS resource configuration capabilities for one or more TRPs associated with the first RAN node; and send, to the first RAN node, a request for start of SL-PRS resource allocation to be performed by the first RAN node, the first RAN node comprising: a processor; a memory storing instructions which, when executed by the processor, cause the first RAN node to: provide, to an LMF, TRP SL-PRS resource configuration capabilities for one or more TRPs associated with the first RAN node; and receive, from the LMF, a request for start of SL-PRS resource allocation to be performed by the first RAN node.

In some embodiments, when the first RAN node is a CU of a base station, the telecommunication system further comprises: a second RAN node comprising: a processor; a memory storing instructions which, when executed by the processor, cause the second RAN node to: provide, to the first RAN node, TRP SL-PRS resource configuration capabilities for one or more TRPs associated with the second RAN node; and receive, from the first RAN node, a request for start of SL-PRS resource allocation to be performed by the second RAN node.

In some embodiments, the instructions stored in the memory of the network node, when executed by the processor of the network node, cause the LMF further to perform any of the methods of the first aspect. In some embodiments, the instructions stored in the memory of the first RAN node, when executed by the processor of the first RAN node, cause the first RAN node further to perform any of the methods of the fourth aspect. In some embodiments, the instructions stored in the memory of the second RAN node, when executed by the processor of the second RAN node, cause the second RAN node further to perform any of the methods of the seventh aspect.

Certain aspects of the disclosure and their embodiments may provide solutions to these or other challenges. Since the serving gNB is in charge of radio resource allocation, the LMF should NOT decide the radio resources. Hence, the SL-PRS configuration is generated by each TRP in each Next Generation Radio Access Network (NG-RAN) node. In a split gNB architecture, the TRPs are hosted in the gNB-DU, while the gNB-CU terminates the NRPPA protocol.

Certain embodiments may provide one or more of the following technical advantage(s):
Following the basic principle that, when in coverage, the serving gNB is always in charge and has the last word on radio resource allocation (consistent with, e.g., UTDOA, among other things); resource pool, if present, should be pre-configured by NG-RAN node, NOT LMF which should remain “ignorant” of radio resources.
Following a unified design where the serving gNB configures the SL-PRS configuration to UE.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary telecommunication network in which SL-PRS configuration handling is applicable according to an embodiment of the present disclosure.

FIG. 2 is a diagram illustrating an exemplary procedure for SL-PRS configuration handling according to an embodiment of the present disclosure.

FIG. 3 is a illustrating an exemplary method at a network node for SL-PRS configuration handling according to an embodiment of the present disclosure.

FIG. 4 is a flow chart illustrating an exemplary method at a first RAN node for SL-PRS configuration handling according to an embodiment of the present disclosure.

FIG. 5 is a flow chart illustrating an exemplary method at a second RAN node for SL-PRS configuration handling according to an embodiment of the present disclosure.

FIG. 6 schematically shows an embodiment of an arrangement which may be used in a network node or RAN nodes according to an embodiment of the present disclosure.

FIG. 7 shows an example of a communication system in accordance with some embodiments of the present disclosure.

FIG. 8 shows an exemplary UE in accordance with some embodiments of the present disclosure.

FIG. 9 shows an exemplary network node in accordance with some embodiments of the present disclosure.

FIG. 10 is a block diagram illustrating an exemplary virtualization environment in which functions implemented by some embodiments may be virtualized.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (5G NR), the present disclosure is not limited thereto. In fact, as long as SL-PRS configuration handling is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), future 6G systems, etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “network node” used herein may refer to or comprise a base station, a base transceiver station, an access point, a hot spot, a NodeB (NB), an evolved NodeB (eNB), a gNB, a network element, a network function, or any other equivalents.

Further, following 3GPP documents are incorporated herein by reference in their entireties:
[1] 3GPP TSG RAN Meeting #91e, RP-210893, “New WID on NR Sidelink Relay”;
[2] 3GPP TS 38.473 V17.2.0 (2022-09), Technical Specification, 3rd Generation Partnership Project; Technical Specification Group Radio Access Network; NG-RAN; F1 application protocol (F1AP) (Release 17);
[3] 3GPP TS 38.455 V17.2.0 (2022-09), Technical Specification, 3rd Generation Partnership Project; Technical Specification Group Radio Access Network; NG-RAN; NR Positioning Protocol A (NRPPa) (Release 17);
[4] 3GPP TS 38.413 V17.2.0 (2022-09), Technical Specification, 3rd Generation Partnership Project; Technical Specification Group Radio Access Network; NG-RAN; NG Application Protocol (NGAP) (Release 17); and
[5] 3GPP TS 38.423 V17.2.0 (2022-09), Technical Specification, 3rd Generation Partnership Project; Technical Specification Group Radio Access Network; NG-RAN; Xn application protocol (XnAP) (Release 17).

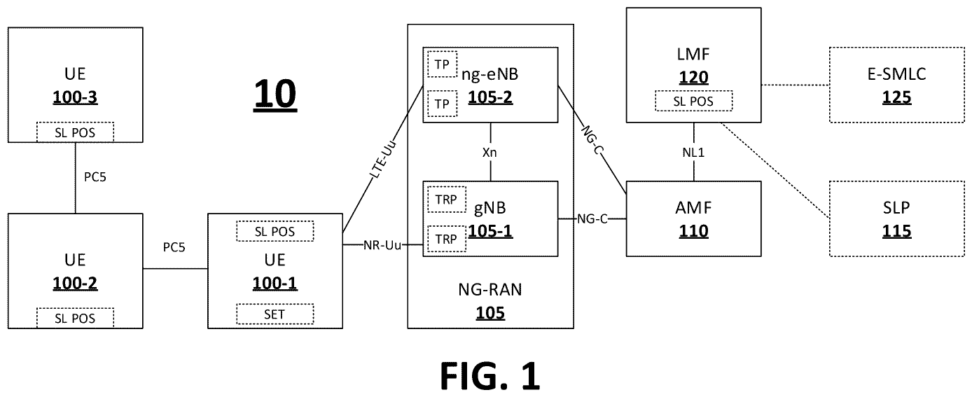

FIG. 1 is a diagram illustrating an exemplary telecommunication system 10 in which SL-PRS configuration handling is applicable according to an embodiment of the present disclosure. Although the telecommunication system 10 is a system defined in the context of 5 GS/NR, the present disclosure is not limited thereto.

As shown in FIG. 1, the system 10 may comprise one or more UEs 100, a Radio Access Network (RAN) 105, and some network nodes/functions related to positioning.

In some embodiments, the RAN 105 may be a Next Generation RAN (NG-RAN). However, the present disclosure is not limited thereto. In some other embodiments, the RAN 105 may be an Evolved Universal Terrestrial Radio Access Network (E-UTRAN) or a RAN based on another RAT. Referring to FIG. 1, the NG-RAN 105 may comprise one or more RAN nodes, such as a gNB 105-1 and an ng-eNB 105-2, which may provide the UE 100 with access based on one or more Radio Access Technologies (RATs). For example, the gNB 105-1 may provide the UE 100 with NR access, and the ng-eNB 105-2 may provide the UE 100 with Evolved Universal Terrestrial Radio Access (E-UTRA) access.

Further, as shown in FIG. 1, the system 10 may further comprise one or more network nodes, such as an Access and Mobility Management Function (AMF) 110, a Secure User Plane Location (SUPL) Location Platform (SLP) 115, an LMF 120, and an Enhanced Serving Mobile Location Center (E-SMLC) 125. Please note that the present disclosure is not limited thereto. In some other embodiments, the system 10 may comprise more nodes, less nodes, or different nodes that can be substituted for the nodes shown in FIG. 1.

Further, as also shown in FIG. 1, an NG-RAN node (e.g., the gNB 105-1, the ng-eNB 105-2) may control several TRPs/Transmission Points (TPs), such as remote radio heads, or DL-PRS-only TPs for support of PRS-based Terrestrial Beacon System (TBS).

As shown in FIG. 1, the UEs 100 may communicate with each other via the PC5 reference point, without relaying their data via the network. For example, the UE 100-1 may communicate with the UE 100-2 via the PC5 link therebetween, without involving the NG-RAN 105, the AMF 110, or any other nodes in the network 10 (e.g., a User Plane Function (UPF)). For another example, the UE 100-2 may communicate with the UE 100-3 via the PC5 link therebetween, without involving the UE 100-1, the NG-RAN 105, the AMF 110, or any other nodes in the network 10.

The following embodiments consider in coverage UE and/or in partial coverage UE, where the sidelink communication is determined by the serving gNB of the UE.

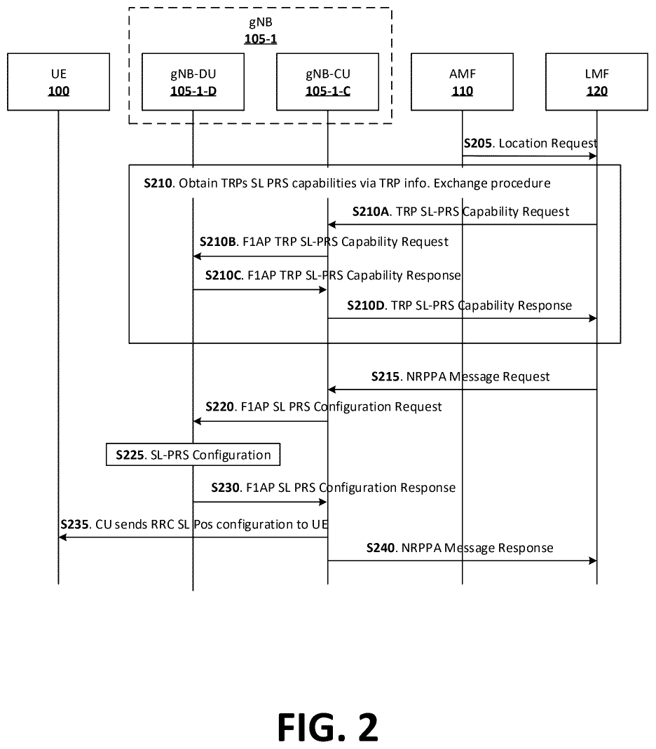

FIG. 2 is a diagram illustrating an exemplary procedure for SL-PRS configuration handling according to an embodiment of the present disclosure. To be specific, FIG. 2 illustrates an exemplary procedure for SL-PRS configuration in a network-controlled mode according to an embodiment of the present disclosure. The steps of the procedure are as follows:

At step S205, the LMF 120 may receive a location request from, for example, the AMF 110.

At step S210, the network (NG-RAN 105, including, e.g., gNB-CU 105-1-C and gNB-DU 105-1-D) and the LMF 120 may exchange TRP capabilities for SL PRS Configuration.

At step S215, the LMF 120 may send some assistance data about pre-configuring SL-PRS to the serving gNB 105-1 (e.g., the gNB-CU 105-1-C in the illustrated example), e.g., in this example in the NRPPA message request. This assistance data may include, in one embodiment, recommended information for pre-configuring SL-PRS by the serving gNB 105-1.

At step S220, when receiving a request (e.g., the request of step S215) for positioning using SL measurements in network-centric operation, the gNB-CU 105-1-C may send a request to the gNB-DU 105-1-D to configure the TRPs for SL-PRS resource allocation. In some embodiments, the requested configuration of the TRPs for SL-PRS resource allocation may be based on the assistance data from step S215.

At steps S225 and S230, the gNB-DU 105-1-D may configure the TRPs for transmitting SL PRS resource allocation with the correct resources and provide a response message to the gNB-CU 105-1-C.

At step S235, the serving gNB-CU 105-1-C may send the SL positioning configuration to the UE 100.

At step S240, a response message of successful configuration and transmission may be sent to the LMF 120.

In some embodiments, the SL PRS configuration received from the LMF 120 at step S215 can be exchanged between different NG-RANs over Xn interface.

Additional details, embodiments, and variations will now be described.

In some embodiments, for network-centric SL-PRS resource allocation, the serving gNB (e.g., the gNB 105-1) should always be in charge of radio resource allocation.

### NRPPA Embodiments

In some embodiments, the LMF 120 may send a query message to the gNB 105-1 (e.g., the gNB-CU 105-1-C in a split gNB architecture) with a new indication to signal the information on the TRPs it is hosting supporting resource allocation for the new SL-PRS (e.g., the step S210A shown in FIG. 2). In some embodiments, this query message including the new indication may be sent from the LMF 120 to the gNB 105-1 (e.g., to the gNB-CU 105-1-C) at step S210 of FIG. 2. In some embodiments, this query message including the new indication may also be referred to herein as a query message with a request for TRP SL PRS resource allocation capability. In some embodiments, the new indication to query which TRPs support resource allocation for the new SL Positioning reference signal may be included as part of TRP INFORMATION REQUEST message defined in 3GPP TS 38.455. In some other embodiments, a new request message may be defined in 3GPP TS 38.455 for the LMF 120 to query which TRPs support resource allocation for the new SL Positioning reference signal.

In some embodiments, upon receiving the query message from the LMF 120 with the request for TRP SL PRS resource allocation capability, the gNB 105-1 (e.g., gNB-CU 105-1-C) may send a response message to the LMF 120 indicating which of its hosted TRPs are capable of configuring UEs with resources for SL PRS, and their local SL-PRS configuration (e.g., the step 210D of FIG. 2). In some embodiments, this response may be sent in, e.g., step S210 of FIG. 2. In some embodiments, the response message indicating which of its hosted TRPs are capable of configuring UEs with resources for SL PRS and their local SL-PRS configuration may include (but is not limited to) providing the UE with SL PRS resource allocation configuration for scheme 2, as well as sending Downlink Control Information (DCI) information to UEs requesting them to transmit the SL PRS. In some embodiments, the new indication(s) of which of the hosted TRPs are capable of SL PRS resource allocation may be part of the TRP INFORMATION RESPONSE message defined in 3GPP TS 38.455. In some other embodiments, the new indication(s) can be a new Information Element (IE) within the TRP Information IE in 3GPP TS 38.455.

In some embodiments, the LMF 120 may send a request, which can be in a new NRPPA message, for start of SL resource allocation to be performed by the gNB 105-1 (e.g., the step S215 of FIG. 2). In some embodiments, the LMF 120 may optionally include assistance data in the request to help the gNB 105-1 perform the SL resource allocation.

In some embodiments, the assistance data signalled from the LMF 120 can include the desired periodicity for the SL-PRS configuration, start time, frequency information, muting pattern, QCL, etc. In some embodiments, the assistance data signalled from the LMF 120 may include whether the SL PRS resource pool should be shared with the resource pool used for SL communications or if the SL PRS resource pool that is a dedicated resource pool separate from the resource pool used for SL communications. In some embodiments, the LMF 120 may receive UE capability signaling from the UE on whether the UE supports common resource pool for SL PRS and SL communication or separate resource pools for SL PRS and SL communications.

In some embodiments, the gNB-CU 105-1 can send a failure message to the LMF 120 in case the SL-PRS resource allocation could not be performed. In some embodiments, this may be done, e.g., at step S240 of FIG. 2.

### F1AP Embodiments

In some embodiments, upon receiving the query message from the LMF 120 with a request for TRP SL PRS resource allocation capability (the query may be the TRP INFORMATION REQUEST message which may include the new request for TRP SL PRS resource allocation capability) (e.g., at step 210A of FIG. 2 as described above), the gNB-CU 105-1-C may send the F1AP equivalent query message to the gNB-DU 105-1-D to request signalling the information on the hosted TRPs supporting resource allocation for the SL-PRS (the step S210B of FIG. 2). In some embodiments, the F1AP equivalent query message may be the F1AP TRP INFORMATION REQUEST message defined in TS 38.473 but includes the new information on the hosted TRPs supporting resource allocation for SL-PRS.

In some embodiments, the gNB-CU 105-1-C can send the SL-PRS recommended resource configuration from the LMF 120 and the assistance data received from the LMF 120 to other gNB-CUs connected over the Xn interface during, e.g., mobility and dual connectivity procedures.

In some embodiments, upon receiving the query message from the gNB-CU 105-1-C with a request for TRP SL PRS resource allocation capability, the gNB-DU 105-1-D may send a response message (e.g., similar to F1 TRP INFORMATION RESPONSE message defined in TS 38.473 but including the TRP SL PRS resource allocation capability) indicating which of its hosted TRPs are capable of configuring UEs with the resource for SL PRS, and their local SL-PRS configuration (e.g., the step S210C of FIG. 2). In some embodiments, this may include (but is not limited to) providing the UE with SL PRS resource allocation configuration for scheme 2, as well as sending DCI information to UEs requesting them to transmit the SL PRS. In some embodiments, these new indications can be a new IE within the TRP Information IE in TS 38.473. In some embodiments, the response from the gNB-DU 105-1-D to the gNB-CU 105-1-C may also be part of step S210 of FIG. 2.

In some embodiments, upon receiving the request from the LMF 120 to configure the SL PRS resource with the assistance information (e.g., periodicity, start time, etc.), if provided, and start resource allocation for sidelink positioning (e.g., at step S215 of FIG. 2), the gNB-CU 105-1-C may send a request, which can be in a new F1AP message, to the gNB-DU 105-1-D for sidelink configuration (e.g., at step S220 of FIG. 2). In some embodiments, the assistance information signalled may include whether the SL PRS resource pool should be shared with the resource pool used for SL communications or if the SL PRS resource pool that is a dedicated resource pool separate from the resource pool used for SL communications.

In some embodiments, the gNB-DU 105-1-D may receive the request to configure the SL PRS transmission for sidelink positioning, taking into account information received from gNB-CU 105-1-C and positioning server, e.g. frequency information, periodicity, resources.

In some embodiments, once the resources have been allocated (e.g., at step S225 of FIG. 2), the gNB-DU 105-1-D may provide a response message to the gNB-CU 105-1-C (e.g., at step S230 of FIG. 2). In some embodiments, the gNB-DU 105-1-D can send a failure message to the gNB-CU 105-1-C in case the SL-PRS could not be configured.

In some embodiments, in case of successful configuration, the gNB-DU 105-1-D may encode the SL PRS configuration in an RRC container and send it to the gNB-CU 105-1-C, which will send it transparently to the UE 100.

In some embodiments, upon receiving the gNB-DU sidelink positioning configuration for the target UE 100, the gNB-CU 105-1-C may transmit it to the UE 100 over an RRC message (e.g., at step S235 of FIG. 2).

In some embodiments, the gNB-CU 105-1-C can send the UE sidelink positioning configuration to other gNB-CUs over the Xn interface.

### RRC Embodiments

For step S235 of FIG. 2 (SL-PRS Configuration in network-controlled mode), the serving gNB-CU 105-1-C may send the SL positioning configuration to the UE 100.

The example below shows an embodiment in which the SL-PRS configuration received from gNB-CU is provided via RRC sidelink configuration from transmitting UE to receiving UE. This is done by extending the SL message class. The SL-PRS configuration can also consist of different SL-PRS configuration resources sets, resources which can be triggered using aperiodic or semi-persistent mechanism or using periodic configuration. The SL-PRS configuration may provide the detail as which SL-PRS Resource set/resources can be configured aperiodic, semi-persistent, and aperiodic.

- SCCH-Message
The SCCH-Message class is the set of RRC messages that may be sent from the UE to the UE for unicast of NR
sidelink communication on SCCH logical channel.
-- ASN1START
-- TAG-SCCH-MESSAGE-START

| | |
|---|---|
| SCCH-Message ::= | SEQUENCE { |
| message | SCCH-MessageType |

}

| | |
|---|---|
| SCCH-MessageType ::= | CHOICE { |
| c1 | CHOICE { |
| measurementReportSidelink | MeasurementReportSidelink, |
| rrcReconfigurationSidelink | RRCReconfigurationSidelink, |
| rrcReconfigurationCompleteSidelink | RRCReconfigurationCompleteSidelink, |
| rrcReconfigurationFailureSidelink | RRCReconfigurationFailureSidelink, |
| ueCapabilityEnquirySidelink | UECapabilityEnquirySidelink, |
| ueCapabilityInformationSidelink | UECapabilityInformationSidelink, |
| uuMessageTransferSidelink-r17 | UuMessageTransferSidelink-r17, |
| remoteUEInformationSidelink-r17 | RemoteUEInformationSidelink-r17 |

},

| | |
|---|---|
| messageClassExtension | CHOICE { |
| c2 | CHOICE { |

```
        notificationMessageSidelink-r17 NotificationMessageSidelink-r17,
        ueAssistanceInformationSidelink-r17 UEAssistanceInformationSidelink-r17,
        sl-PRS-Configuration-r18 SL-PRS-Configuration-r18,
        spare5 NULL, spare4 NULL, spare3 NULL, spare2 NULL, spare1 NULL
    },
```

| | |
|---|---|
| messageClassExtensionFuture-r17 | SEQUENCE { } |

}
}

| | |
|---|---|
| SL-PRS-Configuration-r18 | ::= SEQUENCE { |
| sl-PRS-ResourceSetToReleaseList | SEQUENCE (SIZE(1..maxNrofSL-PRS -ResourceSets)) OF SL- |
| PRS-ResourceSetId | OPTIONAL, -- Need N |
| sl-PRS -ResourceSetToAddModList | SEQUENCE (SIZE(1..maxNrofSL-PRS-ResourceSets)) OF |
| SL-PRS-ResourceSet | OPTIONAL, -- Need N |
| sl-PRS-ResourceToReleaseList | SEQUENCE (SIZE(1..maxNrofSL-PRS-Resources)) OF SL- |
| PRS-ResourceId | OPTIONAL, -- Need N |
| sl-PRS-ResourceToAddModList | SEQUENCE (SIZE(1..maxNrofSL-PRS-Resources)) OF SL- |
| PRS-Resource | OPTIONAL, -- Need N |

}

| | |
|---|---|
| SL-PRS-ResourceSet ::= | SEQUENCE { |
| sl-PRS-ResourceSetId | sl-PRS-ResourceSetId, |
| SL-PRS-ResourceIdList | SEQUENCE (SIZE(1..maxNrofSL-PRS-ResourcesPerSet)) |
| OF SL-PRS-ResourceId | OPTIONAL, -- Cond Setup |
| resourceType | CHOICE { |
| aperiodic | SEQUENCE { |

```
      ...
    },
```

| | |
|---|---|
| semi-persistent | SEQUENCE { |

```
        ...
    },
```

| | |
|---|---|
| periodic | SEQUENCE { |

```
      ...
    }
  },
-- TAG-SCCH-MESSAGE-STOP
-- ASN1STOP
```

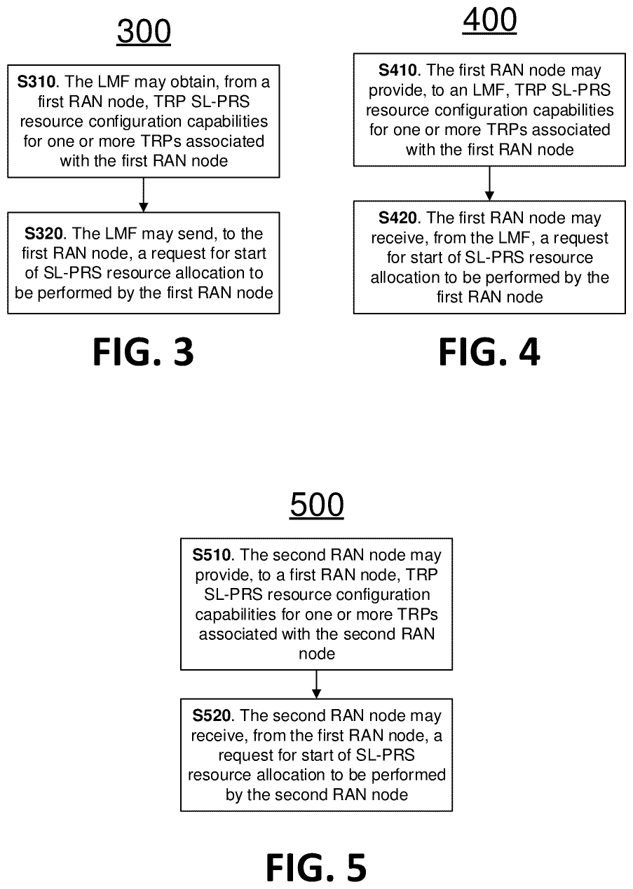

FIG. 3 is a flow chart of an exemplary method 300 performed by a network node for SL-PRS configuration handling according to an embodiment of the present disclosure. The method 300 may be performed at a network node (e.g., the LMF 120 shown in FIG. 1 and FIG. 2). The method 300 may comprise steps S310 and S320. However, the present disclosure is not limited thereto. In some other embodiments, the method 300 may comprise more steps, less steps, different steps, or any combination thereof. Further the steps of the method 300 may be performed in a different order than that described herein. Further, in some embodiments, a step in the method 300 may be split into multiple sub-steps and performed by different entities, and/or multiple steps in the method 300 may be combined into a single step.

The method 300 may begin at step S310 where the LMF may obtain, from a first RAN node, TRP SL-PRS resource configuration capabilities for one or more TRPs associated with the first RAN node.

At step S320, the LMF may send, to the first RAN node, a request for start of SL-PRS resource allocation to be performed by the first RAN node.

In some embodiments, the request for start of SL-PRS resource allocation may comprise assistance data. In some embodiments, the assistance data may comprise one or more recommended parameters for SL-PRS resource allocation that are based on at least the TRP SL-PRS resource configuration capabilities for the one or more TRPs associated with the first RAN node. In some embodiments, the one or more recommended parameters may comprise at least one of: a recommended periodicity for the SL-PRS resource allocation; a start time for the SL-PRS resource allocation; frequency information for the SL-PRS resource allocation; a muting pattern for the SL-PRS resource allocation; and Quasi Co-Location, QCL, information for the SL-PRS resource allocation. In some embodiments, the assistance data may comprise information about whether a SL-PRS resource pool should be shared with a resource pool used for SL communications or whether the SL-PRS resource pool should be a dedicated resource pool separate from the resource pool used for SL communications.

In some embodiments, the method 300 may further comprise: receiving, from one or more UEs, one or more UE capabilities, each of which indicating whether the corresponding UE supports a common resource pool for SL-PRS and SL communications or separate resource pools for SL-PRS and SL communications. In some embodiments, obtaining the TRP SL-PRS resource configuration capabilities for the one or more TRPs associated with the first RAN node may comprise: sending, to the first RAN node, a request for TRP SL-PRS resource configuration capabilities; and receiving, from the first RAN node, a response comprising the TRP SL-PRS resource configuration capabilities for the one or more TRPs associated with the first RAN node in response to the request. In some embodiments, the method 300 may further comprise: in response to sending the request for start of SL-PRS resource allocation, receiving, from the first RAN node, a response indicating whether or not the SL-PRS resource allocation is successfully performed. In some embodiments, the TRP SL-PRS resource configuration capabilities may comprise at least one of: a capability of providing one or more UEs with SL-PRS resource allocation configuration for scheme 2; and a capability of sending DCI information to one or more UEs for requesting the one or more UEs to transmit SL-PRS.

FIG. 4 is a flow chart of an exemplary method 400 performed by a first RAN node for SL-PRS configuration handling according to an embodiment of the present disclosure. The method 400 may be performed at a RAN node (e.g., the gNB 105-1 shown in FIG. 1 and FIG. 2 or the gNB-CU 105-1-C shown in FIG. 2). The method 400 may comprise steps S410 and S420. However, the present disclosure is not limited thereto. In some other embodiments, the method 400 may comprise more steps, less steps, different steps, or any combination thereof. Further the steps of the method 400 may be performed in a different order than that described herein. Further, in some embodiments, a step in the method 400 may be split into multiple sub-steps and performed by different entities, and/or multiple steps in the method 400 may be combined into a single step.

The method 400 may begin at step S410 where the first RAN node may provide, to an LMF, TRP SL-PRS resource configuration capabilities for one or more TRPs associated with the first RAN node.

At step S420, the first RAN node may receive, from the LMF, a request for start of SL-PRS resource allocation to be performed by the first RAN node.

In some embodiments, the request for start of SL-PRS resource allocation may comprise assistance data. In some embodiments, the method 400 may further comprise at least one of: sending, to one or more other RAN nodes, the assistance data received from the LMF; and receiving, from one or more other RAN nodes, assistance data for SL-PRS resource allocation. In some embodiments, the assistance data may comprise one or more recommended parameters for SL-PRS resource allocation that are based on at least the TRP SL-PRS resource configuration capabilities for the one or more TRPs associated with the first RAN node. In some embodiments, the one or more recommended parameters may comprise at least one of: a recommended periodicity for the SL-PRS resource allocation; a start time for the SL-PRS resource allocation; frequency information for the SL-PRS resource allocation; a muting pattern for the SL-PRS resource allocation; and Quasi Co-Location, QCL, information for the SL-PRS resource allocation. In some embodiments, the assistance data may comprise information about whether a SL-PRS resource pool should be shared with a resource pool used for SL communications or whether the SL-PRS resource pool should be a dedicated resource pool separate from the resource pool used for SL communications.

In some embodiments, the method 400 may further comprise: receiving, from the LMF, a request for TRP SL-PRS resource configuration capabilities. In some embodiments, providing the TRP SL-PRS resource configuration capabilities for the one or more TRPs associated with the first RAN node may comprise sending, to the LMF, a response comprising the TRP SL-PRS resource configuration capabilities for the one or more TRPs associated with the first RAN node in response to the request. In some embodiments, the first RAN node may be a CU of a base station. In some embodiments, the method 400 may further comprise: sending, to a DU of the base station, a request for TRP SL-PRS resource configuration capabilities for one or more TRPs associated with the DU; and receiving, from the DU, a response comprising the TRP SL-PRS resource configuration capabilities for one or more TRPs associated with the DU.

In some embodiments, the first RAN node may be a CU of a base station. In some embodiments, the method 400 may further comprise: in response to receiving the request for start of SL-PRS resource allocation to be performed by the first RAN node, sending, to a DU of the base station, a request to configure SL-PRS resources in accordance with at least the request for start of SL-PRS resource allocation received from the LMF. In some embodiments, the request to configure SL-PRS resources may comprise at least a part of the assistance data and/or is at least partially derived from the assistance data. In some embodiments, the method 400 may further comprise: in response to sending the request to configure SL-PRS resources, receiving, from the DU, a response indicating whether or not the SL-PRS resource allocation is performed.

In some embodiments, the method 400 may further comprise: sending, to the LMF, a response indicating whether or not the SL-PRS resource allocation is performed based on at least the response received from the DU indicating whether or not the SL-PRS resource allocation is performed. In some embodiments, when the response received from the DU indicates a successful SL-PRS resource allocation, the response may further comprise an RRC container in which an SL-PRS resource configuration is encoded. In some embodiments, the method 400 may further comprise: sending to a User Equipment, UE, a message comprising the RRC container in which the SL-PRS resource configuration is encoded. In some embodiments, the method 400 may further comprise at least one of: sending, to one or more other RAN nodes, the SL-PRS resource configuration; and receiving, from one or more other RAN nodes, one or more SL-PRS resource configurations for one or more UEs.

In some embodiments, the TRP SL-PRS resource configuration capabilities may comprise at least one of: a capability of providing one or more UEs with SL-PRS resource allocation configuration for scheme 2; and a capability of sending Downlink Control Information, DCI, information to one or more UEs for requesting the one or more UEs to transmit SL-PRS.

FIG. 5 is a flow chart of an exemplary method 500 performed by a second RAN node for SL-PRS configuration handling according to an embodiment of the present disclosure. The method 500 may be performed at a RAN node (e.g., the gNB-DU 105-1-D shown in FIG. 2). The method 500 may comprise steps S510 and S520. However, the present disclosure is not limited thereto. In some other embodiments, the method 500 may comprise more steps, less steps, different steps, or any combination thereof. Further the steps of the method 500 may be performed in a different order than that described herein. Further, in some embodiments, a step in the method 500 may be split into multiple sub-steps and performed by different entities, and/or multiple steps in the method 500 may be combined into a single step.

The method 500 may begin at step S510 where the second RAN node may provide, to a first RAN node, TRP SL-PRS resource configuration capabilities for one or more TRPs associated with the second RAN node.

At step S520, the second RAN node may receive, from the first RAN node, a request for start of SL-PRS resource allocation to be performed by the second RAN node.

In some embodiments, the request for start of SL-PRS resource allocation may comprise assistance data. In some embodiments, the assistance data may comprise one or more recommended parameters for SL-PRS resource allocation that are based on at least the TRP SL-PRS resource configuration capabilities for the one or more TRPs associated with the second RAN node. In some embodiments, the one or more recommended parameters may comprise at least one of: a recommended periodicity for the SL-PRS resource allocation; a start time for the SL-PRS resource allocation; frequency information for the SL-PRS resource allocation; a muting pattern for the SL-PRS resource allocation; and Quasi Co-Location, QCL, information for the SL-PRS resource allocation. In some embodiments, the assistance data may comprise information about whether a SL-PRS resource pool should be shared with a resource pool used for SL communications or whether the SL-PRS resource pool should be a dedicated resource pool separate from the resource pool used for SL communications.

In some embodiments, the method 500 may further comprise: receiving, from the first RAN node, a request for TRP SL-PRS resource configuration capabilities. In some embodiments, providing the TRP SL-PRS resource configuration capabilities for the one or more TRPs associated with the second RAN node may comprise sending, to the first RAN node, a response comprising the TRP SL-PRS resource configuration capabilities for the one or more TRPs associated with the second RAN node in response to the request. In some embodiments, the second RAN node may be a DU of a base station and the first RAN node is a CU of the base station, and the method 500 may further comprise: in response to receiving the request for start of SL-PRS resource allocation to be performed by the second RAN node, configuring SL-PRS resources in accordance with at least the request for start of SL-PRS resource allocation received from the first RAN node. In some embodiments, the method 500 may further comprise: transmitting, to the first RAN node, a response indicating whether or not the SL-PRS resource allocation is performed based on at least whether or not the SL-PRS resources are configured successfully. In some embodiments, when the SL-PRS resources are configured successfully, the response may further comprise an RRC container in which an SL-PRS resource configuration is encoded by the second RAN node. In some embodiments, the TRP SL-PRS resource configuration capabilities may comprise at least one of: a capability of providing one or more UEs with SL-PRS resource allocation configuration for scheme 2; and a capability of sending DCI information to one or more UEs for requesting the one or more UEs to transmit SL-PRS.

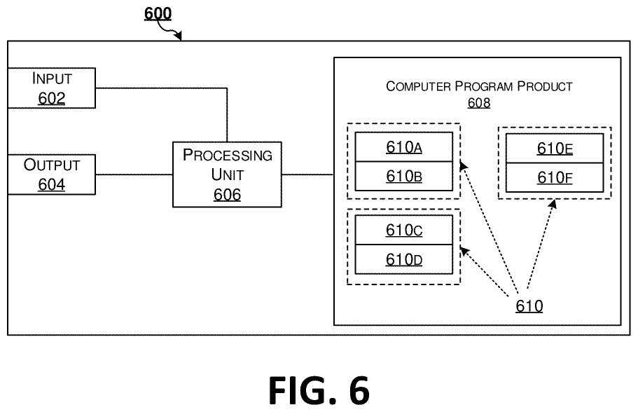

FIG. 6 schematically shows an embodiment of an arrangement which may be used in a network node and/or RAN nodes according to an embodiment of the present disclosure. Comprised in the arrangement 600 are a processing unit 606, e.g., with a Digital Signal Processor (DSP) or a Central Processing Unit (CPU). The processing unit 606 may be a single unit or a plurality of units to perform different actions of procedures described herein. The arrangement 600 may also comprise an input unit 602 for receiving signals from other entities, and an output unit 604 for providing signal(s) to other entities. The input unit 602 and the output unit 604 may be arranged as an integrated entity or as separate entities.

Furthermore, the arrangement 600 may comprise at least one computer program product 608 in the form of a non-volatile or volatile memory, e.g., an Electrically Erasable Programmable Read-Only Memory (EEPROM), a flash memory and/or a hard drive. The computer program product 608 comprises a computer program 610, which comprises code/computer readable instructions, which when executed by the processing unit 606 in the arrangement 600 causes the arrangement 600 and/or the network node and/or the RAN nodes in which it is comprised to perform the actions, e.g., of the procedure described earlier in conjunction with FIG. 2 through FIG. 5 or any other variant.

The computer program 610 may be configured as a computer program code structured in computer program modules 610A and 610B. Hence, in an exemplifying embodiment when the arrangement 600 is used in a network node for SL-PRS configuration handling, the code in the computer program of the arrangement 600 includes: a module 610A configured to obtain, from a first RAN node, TRP SL-PRS resource configuration capabilities for one or more TRPs associated with the first RAN node; and a module 610B configured to send, to the first RAN node, a request for start of SL-PRS resource allocation to be performed by the first RAN node.

Additionally or alternatively, the computer program 610 may be further configured as a computer program code structured in computer program modules 610C and 610D. Hence, in an exemplifying embodiment when the arrangement 600 is used in a first RAN node for SL-PRS configuration handling, the code in the computer program of the arrangement 600 includes: a module 610C configured to provide, to an LMF, TRP SL-PRS resource configuration capabilities for one or more TRPs associated with the first RAN node; and a module 610D configured to receive, from the LMF, a request for start of SL-PRS resource allocation to be performed by the first RAN node.

Additionally or alternatively, the computer program 610 may be further configured as a computer program code structured in computer program modules 610E and 610F. Hence, in an exemplifying embodiment when the arrangement 600 is used in a second RAN node for SL-PRS configuration handling, the code in the computer program of the arrangement 600 includes: a module 610E configured to provide, to a first RAN node, TRP SL-PRS resource configuration capabilities for one or more TRPs associated with the second RAN node; and a module 610F configured to receive, from the first RAN node, a request for start of SL-PRS resource allocation to be performed by the second RAN node.

The computer program modules could essentially perform the actions of the flow illustrated in FIG. 2 through FIG. 5, to emulate the network node and/or the RAN nodes. In other words, when the different computer program modules are executed in the processing unit 606, they may correspond to different modules in the network node and/or the RAN nodes.

Although the code means in the embodiments disclosed above in conjunction with FIG. 6 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the network node and/or the RAN nodes.

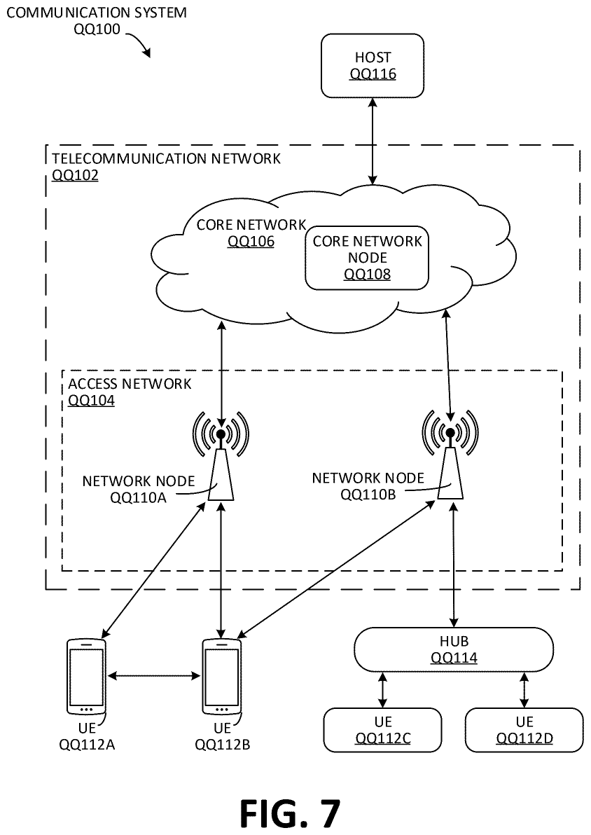

FIG. 7 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

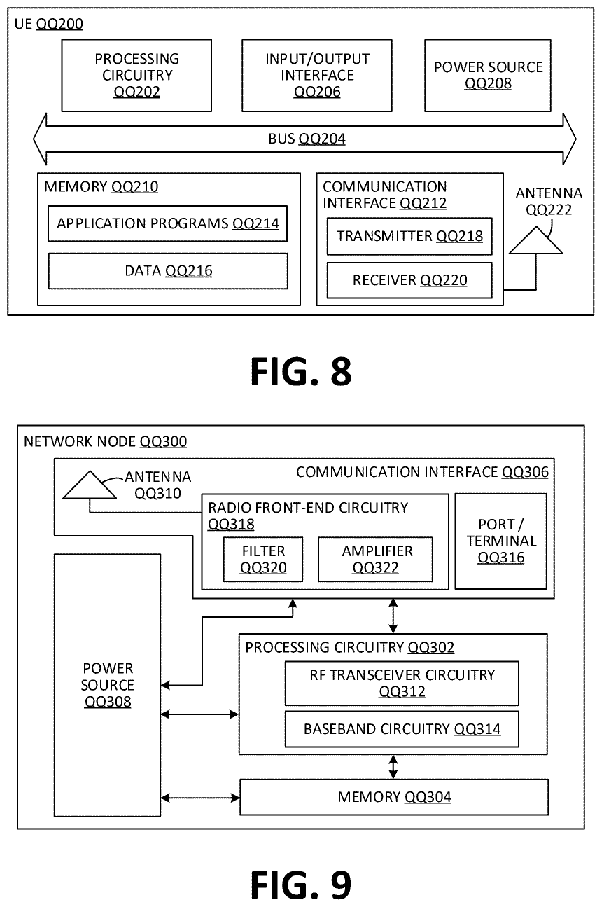

FIG. 8 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAS), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 9 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

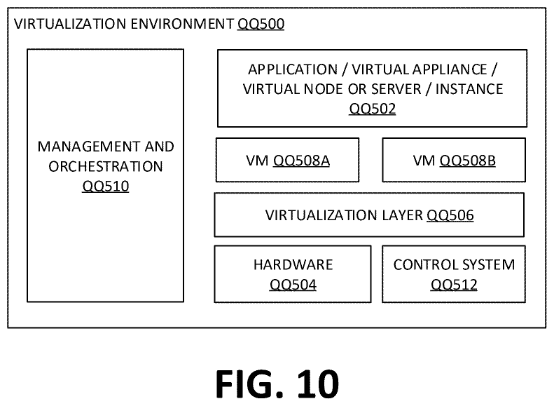

FIG. 10 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| LCS | LoCation Service |
| LMF | Location Management Function |
| MT-LR | Mobile Terminated Location Request |
| ProSE | Proximity Services |
| PRS | Positioning Reference Signal |
| SL | Sidelink |
| UE | User Equipment |

1-11. (canceled)

12. A method performed by a first Radio Access Network, RAN, node, the method comprising:
providing, to a Location Management Function, LMF, Transmission and Reception Point, TRP, Sidelink Positioning Reference Signal, SL-PRS, resource configuration capabilities for one or more TRPs associated with the first RAN node; and
receiving, from the LMF, a request for start of SL-PRS resource allocation to be performed by the first RAN node, wherein the request for start of SL-PRS resource allocation comprises assistance data.

13. (canceled)

14. The method of claim 12, further comprising at least one of:
sending, to one or more other RAN nodes, the assistance data received from the LMF; and
receiving, from one or more other RAN nodes, assistance data for SL-PRS resource allocation.

15. The method of claim 13, wherein the assistance data comprises one or more recommended parameters for SL-PRS resource allocation that are based on at least the TRP SL-PRS resource configuration capabilities for the one or more TRPs associated with the first RAN node; wherein the one or more recommended parameters comprise at least one of:
a recommended periodicity for the SL-PRS resource allocation;
a start time for the SL-PRS resource allocation;
frequency information for the SL-PRS resource allocation;
a muting pattern for the SL-PRS resource allocation; and
Quasi Co-Location, QCL, information for the SL-PRS resource allocation.

16. (canceled)

17. The method of claim 14, wherein the assistance data comprises information about whether a SL-PRS resource pool should be shared with a resource pool used for SL communications or whether the SL-PRS resource pool should be a dedicated resource pool separate from the resource pool used for SL communications.

18. (canceled)

19. The method of claim 12, wherein the first RAN node is a Centralized Unit, CU, of a base station, and
wherein the method further comprises:
sending, to a Distributed Unit, DU, of the base station, a request for TRP SL-PRS resource configuration capabilities for one or more TRPs associated with the DU; and
receiving, from the DU, a response comprising the TRP SL-PRS resource configuration capabilities for one or more TRPs associated with the DU.

20. The method of claim 12, wherein the first RAN node is a Centralized Unit, CU, of a base station, and
wherein the method further comprises:
in response to receiving the request for start of SL-PRS resource allocation to be performed by the first RAN node, sending, to a Distributed Unit, DU, of the base station, a request to configure SL-PRS resources in accordance with at least the request for start of SL-PRS resource allocation received from the LMF.

21. The method of claim 20, wherein the request to configure SL-PRS resources comprises at least a part of the assistance data and/or is at least partially derived from the assistance data.

22. The method of claim 20, further comprising:
in response to sending the request to configure SL-PRS resources, receiving, from the DU, a response indicating whether or not the SL-PRS resource allocation is performed.

23. The method of claim 22, further comprising:
sending, to the LMF, a response indicating whether or not the SL-PRS resource allocation is performed based on at least the response received from the DU indicating whether or not the SL-PRS resource allocation is performed.

24. The method of claim 22, wherein when the response received from the DU indicates a successful SL-PRS resource allocation, the response further comprises a Radio Resource Control, RRC, container in which an SL-PRS resource configuration is encoded.

25. The method of claim 24, further comprising:
sending to a User Equipment, UE, a message comprising the RRC container in which the SL-PRS resource configuration is encoded.

26. The method of claim 25, further comprising at least one of:
sending, to one or more other RAN nodes, the SL-PRS resource configuration; and
receiving, from one or more other RAN nodes, one or more SL-PRS resource configurations for one or more UEs.

27. The method of claim 12, wherein the TRP SL-PRS resource configuration capabilities comprise at least one of:
a capability of providing one or more UEs with SL-PRS resource allocation configuration for scheme 2; and
a capability of sending Downlink Control Information, DCI, information to one or more UEs for requesting the one or more UEs to transmit SL-PRS.

28. A first RAN node comprising:
a processor;
a memory storing instructions which, when executed by the processor, cause the first RAN node to:
provide, to an LMF, TRP SL-PRS resource configuration capabilities for one or more TRPs associated with the first RAN node; and
receive, from the LMF, a request for start of SL-PRS resource allocation to be performed by the first RAN node.

29. (canceled)

30. A method performed by a second RAN node, the method comprising:
providing, to a first RAN node, TRP SL-PRS resource configuration capabilities for one or more TRPs associated with the second RAN node; and
receiving, from the first RAN node, a request for start of SL-PRS resource allocation to be performed by the second RAN node, wherein the request for start of SL-PRS resource allocation comprises assistance data.

31. (canceled)

32. The method of claim 31, wherein the assistance data comprises one or more recommended parameters for SL-PRS resource allocation that are based on at least the TRP SL-PRS resource configuration capabilities for the one or more TRPs associated with the second RAN node; wherein the one or more recommended parameters comprise at least one of:
a recommended periodicity for the SL-PRS resource allocation;
a start time for the SL-PRS resource allocation;
frequency information for the SL-PRS resource allocation;
a muting pattern for the SL-PRS resource allocation; and
Quasi Co-Location, QCL, information for the SL-PRS resource allocation.

33. (canceled)

34. The method of claim 30, wherein the assistance data comprises information about whether a SL-PRS resource pool should be shared with a resource pool used for SL communications or whether the SL-PRS resource pool should be a dedicated resource pool separate from the resource pool used for SL communications.

35. (canceled)

36. The method of claim 30, wherein the second RAN node is a DU of a base station and the first RAN node is a CU of the base station, and
wherein the method further comprises:
in response to receiving the request for start of SL-PRS resource allocation to be performed by the second RAN node, configuring SL-PRS resources in accordance with at least the request for start of SL-PRS resource allocation received from the first RAN node.

37. The method of claim 36, further comprising:
transmitting, to the first RAN node, a response indicating whether or not the SL-PRS resource allocation is performed based on at least whether or not the SL-PRS resources are configured successfully; wherein when the SL-PRS resources are configured successfully, the response further comprises a Radio Resource Control, RRC, container in which an SL-PRS resource configuration is encoded by the second RAN node.

38. (canceled)

39. The method of claim 30, wherein the TRP SL-PRS resource configuration capabilities comprise at least one of:
a capability of providing one or more UEs with SL-PRS resource allocation configuration for scheme 2; and
a capability of sending Downlink Control Information, DCI, information to one or more UEs for requesting the one or more UEs to transmit SL-PRS.

40-48. (canceled)
